(19) United States
(12) Patent Application Publication
(10) Pub. No.: US 2014/0244656 A1
(43) Pub. Date: Aug. 28, 2014

(54) TRANS-COMMUNITY SEARCH METHOD AND APPARATUS

(71) Applicant: TENCENT TECHNOLOGY (SHENZHEN) COMPANY LIMITED, Shenzhen (CN)

(72) Inventors: Yue CAO, Shenzhen (CN); Yuancheng CAO, Shenzhen (CN); Rui LIU, Shenzhen (CN); Wei ZOU, Shenzhen (CN); Junsong YANG, Shenzhen (CN); Wei SUN, Shenzhen (CN)

(73) Assignee: TENCENT TECHNOLOGY (SHENZHEN) COMPANY LIMITED, Shenzhen (CN)

(21) Appl. No.: 14/270,761

(22) Filed: May 6, 2014

Related U.S. Application Data
(63) Continuation of application No. PCT/CN2013/074299, filed on Apr. 17, 2013.

(30) Foreign Application Priority Data
May 10, 2012 (CN) 201210143271.3

(51) Int. Cl. G06F 17/30

(52) U.S. Cl. CPC G06F 17/30864
USPC 707/741; 707/774; 707/756

(57) ABSTRACT

A trans-community search method and apparatus is disclosed. The method includes: receiving a search request from a user and determining online communities used by the user according to user attribute information contained in the search request; generating a sub-search request corresponding to each online community used by the user according to the search request and acquiring a search result corresponding to the sub-search request; combining search results corresponding to all sub-search requests and sending the combined search results to the user. The invention can improve search efficiency for users.

### CROSS-REFERENCES TO RELATED APPLICATIONS

This application is a continuation of International Application No. PCT/CN2013/074299, filed on Apr. 17, 2013, which claims the priority of Chinese Application No. 201210143271.3, entitled “TRANS-COMMUNITY SEARCH METHOD AND APPARATUS” and filed on May 10, 2012, the content of which are incorporated herein by reference in their entirety.

### FIELD OF THE INVENTION

The present application relates to the field of search engine technologies, and in particular, to a trans-community search method and apparatus.

### BACKGROUND OF THE INVENTION

Users are dramatically increased in the rapidly growing online communities, and it is necessary for the online communities to allow the users, especially friends, to follow and interact with each other. Any user is allowed to search for contents created by himself/herself or friends thereof in an online community, for example, to search for an article posted or forwarded by himself/herself, an article posted by a friend with regard to a certain topic (such as “iPhone 4S”), and so on.

Currently, when a user searches for contents created by himself/herself or friends thereof in the online community, search results that are related to the key word used for searching by the user are filtered based on a relationship chain of the user. However, the obtained search result is limited to the contents created by the user and the friends thereof within the same online community. Due to the fact that most users use multiple online communities, if a user intends to obtain search results from all the multiple online communities, the user needs to log in each of the online communities for searching and then consolidate the search results, which is quite bothering and inefficient.

### SUMMARY OF THE INVENTION

In view of this, a trans-community search method, which provides a user with an improved search efficiency, is provided.

The present disclosure provides a trans-community search method, including:

receiving a search request from a user and determining online communities used by the user according to user attribute information contained in the search request;

generating a sub-search request corresponding to each of the online communities used by the user according to the search request and acquiring a search result corresponding to the sub-search request; and

combining search results corresponding to all sub-search requests and sending the combined search results to the user.

The disclosure further provides a trans-community search apparatus, including a receiving unit, a community determining unit, a search unit and an output unit, where:

the receiving unit is configured to receive a search request from a user;

the community determining unit is configured to determine online communities used by the user according to user attribute information contained in the search request;

the search unit is configured to generate a sub-search request corresponding to each of the online communities used by the user according to the search request and acquire a search result corresponding to the sub-search request; and

the output unit is configured to combine search results corresponding to all sub-search requests and send the combined search results to the user.

The disclosure further provides a machine-readable medium stored with an instruction set, and the instruction set, when executed by a machine, is configured to instruct the machine to execute the trans-community search method described above.

It is obvious from the above technical solution of the disclosure that, upon receipt of a search request from a user, multiple sub-search requests are generated based on online communities used by the user, a search result corresponding to each of the sub-search requests is acquired, and then all the search results are combined and sent to the user. In the disclosure, the search results in all online communities used by the user can be acquired through the searching by the user once, thereby providing the user with the improved search efficiency.

### DESCRIPTION OF THE DRAWINGS

FIG. 1 is a schematic diagram showing a network topology of an embodiment of the disclosure;

FIG. 2 is a flowchart of a trans-community search method according to an embodiment of the disclosure; and

FIG. 3 is a schematic structural diagram of a trans-community search apparatus according to an embodiment of the disclosure.

### DETAILED DESCRIPTION OF THE EMBODIMENTS

To make the purposes, technical solutions, and advantages of the disclosure more apparent, the technical solutions provided in the disclosure are elaborated with reference to the accompanying drawings and embodiments.

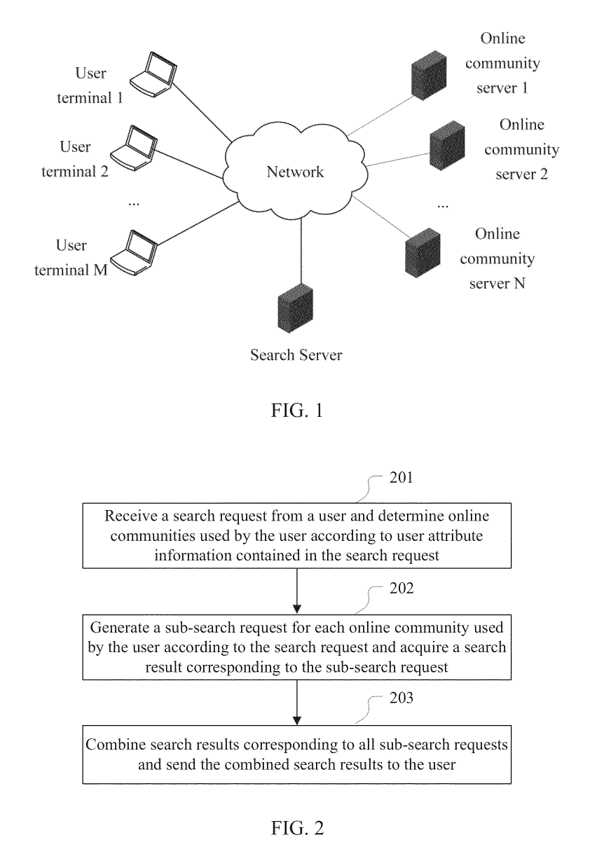

FIG. 1 is a schematic diagram showing the network topology of an embodiment of the disclosure, including user terminals 1, 2, . . . , M, online community servers 1, 2, . . . , N, and a search server that provides a trans-community search service, where, the online community severs 1, 2, . . . , N respectively serve online communities 1, 2, . . . , N by providing various service functions for the online communities. The user terminal may be a device with a network access function such as a computer. A user can access a network via the user terminal, and then access, over the network, the online community servers and a search server that are connected to the same network.

A search server for providing a trans-community search function is required to determine all online communities used by each user, acquire data information of the user in each of the online communities used by the user, and create an index for each piece of data information of the user in the online community. The data information of the user herein may be various text information created by the user in the online community, such as logs, novels and comments. In addition, the search server also needs to acquire a user relationship chain of each user in each online community used by the user, where the user relationship chain of each user in each online community used by the user includes friend information of the user in the online community, for example, a community user identifier of a friend of the user in the online community.

In practical applications, a user usually uses multiple online communities. When registering with an online community, the user needs to provide user characteristic information uniquely identifying the real identity of the user, such as an email address and an instant messenger account (e.g. a QQ account). Such user characteristic information can be used to identify the user and determine all online communities used by the user.

For this purpose, attribute information (e.g. a user identifier) and characteristic information of each user may be pre-stored. The search server provides a user registration function, to acquire and store the identifier and user characteristic information of a user when the user registers with the search server. In specific implementations, a user registration interface is provided at the search server, so that the user is allowed to fill in the user registration interface with his/her attribute information and user characteristic information and click a registration trigger button, to generate a registration request which is sent to the search server for user registration. In this way, the search server acquires and stores the user attribute information and user characteristic information carried in the registration request.

Determining all online communities used by each user may specifically include: acquiring user characteristic information of each community user in each online community, searching for a user with user characteristic information that is the same as that of the community user; and if such user with user characteristic information that is the same as that of the community user is searched out, determining that the online community containing the community user is an online community used by the user searched out. The user characteristic information herein includes at least one of first characteristic information, second characteristic information and third characteristic information, where the first characteristic information includes a name, an age and an address information (in the case of a real-name system); the second characteristic information includes an instant messenger account; and the third characteristic information includes an email address.

After the online communities used by each user are determined using the above method, a community-user mapping table corresponding to the user may be further generated. In acquiring the user characteristic information of each community user in each online community, the community user attribute information of the community user (such as the identifier of the community user) may also be acquired. When it is determined that the online community containing the community user is an online community used by the user searched out, the attribute information of the user searched out, information of the online community and the attribute information of the community user may be added to the community-user mapping table corresponding to the user searched out.

In practical applications, an online community usage submitting function may be further provided for the user at the search server. For example, the online community usage submitting interface may be configured and opened by the user, to fill in and submit online community usage information of the user. The online community usage information includes information of each online community used by the user and the community user attribute information of the user in each online community used by the user.

Thus, after the search server receives the online community usage information submitted by a user via the online community usage submitting interface, it is possible for the search server to determine, according to information of each online community that is contained in the online community usage information submitted by the user, online communities used by the user. In addition, the attribute information of the user, the information of each online community used by the user, and the community user attribute information of the user in each online community used by the user may be added to the corresponding community-user mapping table.

The specific content of the community-user mapping table may be as shown in Table 1.

TABLE 1

| | | Community |
|---|---|---|
| | | User Attribute |
| Attribute | Information of | Information of |
| Information | Online Community | the User in the |
| of the User | Used by the User | Online Community |
| 100 | AAA | AAA100 |
| | BBB | BBB100 |

In Table 1, the attribute information (identifier) of the user is 100; two online communities AAA and BBB are used by the user; and the community user attribute information in the online community AAA is AAA100, while the community user attribute information in the online community BBB is BBB100. The specific form of the community-user mapping table is not limited to Table 1.

Acquiring user characteristic information and community user attribute information of each community user in each online community includes: actively downloading, from an online community server of each online community, the user characteristic information and community user attribute information of each community user in the online community; or receiving the user characteristic information and community user attribute information of each community user in each online community, which is pushed by an online community server of the online community in a preset format.

The above acquiring a user relationship chain and data information of a user in each online community used by the user includes: actively downloading the user relationship chain and the data information of the user in the online community, or receiving the user relationship chain and the data information of the user in the online community from an online community server of the online community, where the online community server pushes the user relationship chain and the data information in a preset format. For example, the format used for pushing the user relationship chain of a user in an online community may include: information of the online community, community user attribute information of the user in the online community, and friend information of the user in the online community; or include: information of the online community, community user attribute information of the user in the online community, and data information of the user in the online community.

Based on the acquired user relationship chain and data information of each user in each online community used by the user, as well as an index created for each piece of data information of the user in each online community, it is possible for the user to conduct a trans-community search, which is described with reference to FIG. 2.

FIG. 2 is a flowchart of a trans-community search method provided in an embodiment of the disclosure. The method includes the following steps 201-203.

Step 201: Receiving a search request from a user and determining, according to user attribute information contained in the search request, online communities used by the user.

In an actual application, a search server needs to provide a login function and a login interface for the user, so that the user is allowed to fill in the user login interface with an identifier and password of the user and click a login trigger button, to generate a login request which is then sent to the search server for user authentication, thereby completing the user login.

When a user needs to search for contents created by himself/herself or his/her friends in all online communities used by the user, the user logs in the search server and then sends a search request to the search server via a user terminal. The search request carries user attribute information and a keyword. In a specific implementation, the user is allowed to input the keyword via a search interface provided by the search server and click a corresponding search triggering button, to generate the search request which is then sent to the search server.

The above determining online communities used by the user according to the user attribute information contained in the search request includes: searching for a community-user mapping table corresponding to the user according to the user attribute information contained in the search request, and determining the online communities used by the user according to online community information in the searched out community-user mapping table.

Step 202: Generating a sub-search request corresponding to each online community used by the user according to the search request and acquiring a search result corresponding to the sub-search request.

In Step 202, generating a sub-search request corresponding to each online community used by the user according to the search request includes: adding a keyword contained in the search request, information of the online community, and the user relationship chain of the user in the online community into a sub-search request, where the user relationship chain of the user in each online community includes friend information of the user in the online community.

The above acquiring a search result corresponding to the sub-search request includes: searching for all data information corresponding to the keyword contained in the sub-search request, according to indexes created for data information of each user in each online community used by the user, and filtering the data information using the online community information and the user relationship chain of the user in the online community, which are carried in the sub-search request, to acquire the search result corresponding to the sub-search request.

Step 203: Combining search results corresponding to all sub-search requests and sending the combined search results to the user.

Herein, the search results may be sorted in any search result sorting method in the prior art.

The trans-community search method provided in an embodiment of the disclosure has been described in detail. The disclosure also provides a trans-community search apparatus which is applied to the above-described search server.

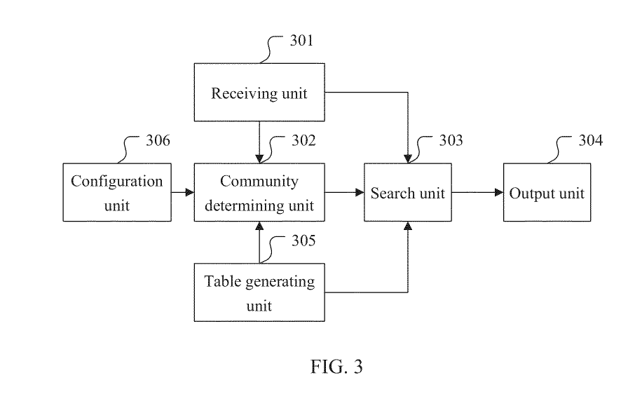

Referring to FIG. 3 which is a structural representation of a trans-community search apparatus provided in an embodiment of the disclosure, the apparatus includes a receiving unit 301, a community determining unit 302, a search unit 303 and an output unit 304.

The receiving unit 301 is configured to receive a search request from a user.

The community determining unit 302 is configured to determine online communities used by the user according to user attribute information contained in the search request.

The search unit 303 is configured to generate a sub-search request corresponding to each online community used by the user according to the search request and acquire search result corresponding to the sub-search request.

The output unit 304 is configured to combine the search results corresponding to all sub-search requests and send the combined search results to the user.

The apparatus further includes a table generating unit 305.

The table generating unit 305 is configured to pre-determine online communities used by each user and generate a community-user mapping table corresponding to the user, where the community-user mapping table includes information of each online community used by the user.

The community determining unit 302 is configured to, when determining online communities used by the user according to user attribute information contained in the search request, search for a community-user mapping table corresponding to the user according to the user attribute information contained in the search request, and determine the online communities used by the user according to online community information in the searched out community-user mapping table.

The table generating unit 305 is configured to pre-store attribute information and characteristic information of each user as well as information of each online community.

The table generating unit 305 is configured to, when pre-determining online communities used by each user and generating a community-user mapping table corresponding to the user, acquire characteristic information of each community user in each online community and search for a user with characteristic information the same as that of the community user; and if such a user with characteristic information the same as that of the community user is searched out, determine that the online community containing the community user is an online community used by the user searched out, and add the attribute information of the user searched out, information of the online community, and attribute information of the community user to a community-user mapping table corresponding to said each user.

The user characteristic information includes at least one of first characteristic information, second characteristic information and third characteristic information, where the first characteristic information includes a name, an age and an address; the second characteristic information includes an instant messenger account; and the third characteristic information includes an email address.

The apparatus further includes a configuration unit 306.

The configuration unit 306 is configured to preset an online community usage submitting interface.

The table generating unit 305 is configured to: when pre-determining online communities used by each user and generating a community-user mapping table corresponding to the user, receive online community usage information which is submitted by the user using the preset online community usage submitting interface, where the online community usage information includes information of each online community used by the user and community user attribute information of the user in each online community used by the user; determine the online communities used by the user according to the information of each online community that is contained in the online community usage information submitted by the user; and add the attribute information of the user, the information of each online community used by the user, and the community user attribute information of the user in each online community used by the user to a community-user mapping table corresponding to the user.

The user attribute information is an identifier of a user.

The information of an online community is an identifier (ID) of the online community.

The community user attribute information is an identifier of a community user in an online community containing the community user.

In the apparatus, the search request further includes a keyword.

The search unit 303 is configured to: when generating a sub-search request corresponding to each online community used by the user according to the search request, add the keyword contained in the search request, information of the online community, and the user relationship chain of the user in the online community into a sub-search request, where the user relationship chain of the user in each online community includes friend information of the user in the online community.

The search unit 303 is configured to, when acquiring a search result corresponding to the sub-search request, search for all data information corresponding to the keyword contained in the sub-search request, according to indexes created for data information of each user in each online community used by the user, and filter the searched out data information using the online community identifier and the user relationship chain of the user in the online community, which are carried in the sub-search request, to acquire the search result corresponding to the sub-search request.

An embodiment of the disclosure further provides a trans-community search device which includes a storage device configured to store instructions and one or more processors which are coupled to the storage device. The one or more processors are configured to execute the instructions stored in the storage device, and perform the trans-community search method according to any of the above various embodiments. In addition, an embodiment of the disclosure further provides a machine-readable medium containing an instruction set, and the instruction set, when executed, is configured to instruct the machine to perform the trans-community search method according to any of the above various embodiments. In the embodiment, the machine-readable medium may be a non-transitory machine-readable medium.

Although the present invention has been described with some preferred embodiments, the present invention is not limited to such embodiments. Any modifications, equivalent replacements, or improvements made without departing from the concept and principles of the invention shall be within the scope of the invention.

What is claimed is:

1. A trans-community search method, comprising:
receiving a search request from a user and determining online communities used by the user according to user attribute information carried in the search request;
generating a sub-search request corresponding to each online community used by the user according to the search request and acquiring a search result corresponding to the sub-search request; and
combining search results corresponding to all sub-search requests and sending the combined search results to the user.

2. The trans-community search method according to claim 1, further comprising: pre-determining the online communities used by each user and generating a community-user mapping table corresponding to the user, wherein the community-user mapping table comprises information of each online community used by the user;
wherein, determining online communities used by the user according to user attribute information carried in the search request comprises: searching for a community-user mapping table corresponding to the user according to the user attribute information carried in the search request and determining the online communities used by the user according to online community information in the searched out community-user mapping table.

3. The trans-community search method according to claim 2, further comprising pre-storing attribute information and characteristic information of each user and information of each online community;
wherein, the community-user mapping table further comprises community user attribute information of the user in each online community used by the user; and
pre-determining the online communities used by each user and generating a community-user mapping table corresponding to the user comprises: acquiring the attribute information and characteristic information of each community user in each online community, searching for a user with the same characteristic information as the community user; and if the user with the same characteristic information as the community user is searched out, determining the online community containing the community user as an online community used by the user searched out, and adding attribute information of the user searched out, information of the online community, and the attribute information of the community user to a community-user mapping table corresponding to the user searched out.

4. The trans-community search method according to claim 3, wherein:
the user characteristic information comprises at least one of first characteristic information, second characteristic information and third characteristic information, wherein the first characteristic information comprises a name, an age and an address, the second characteristic information comprises an instant messenger account, and the third characteristic information comprises an email address.

5. The trans-community search method according to claim 2, further comprising:
presetting an online community usage submitting interface; and
pre-storing attribute information of each user and information of each online community; and
pre-determining the online communities used by each user and generating a community-user mapping table corresponding to the user comprises: receiving online community usage information which is submitted by the user using the preset online community usage submitting interface, where the online community usage information comprises information of each online community used by the user and community user attribute information of the user in each online community used by the user; determining the online communities used by the user according to the information of each online community that is contained in the online community usage information submitted by the user; and adding the attribute information of the user, the information of each online community used by the user, and the community user attribute information of the user in each online community used by the user to a community-user mapping table corresponding to the user.

6. The trans-community search method according to claim 2, wherein:
the user attribute information is an identifier of a user;
the online community information is an identifier ID of an online community; and
the community user attribute information is an identifier of a community user in an online community containing the community user.

7. The trans-community search method according to claim 1, wherein:
the search request further comprises a keyword;
generating a sub-search request corresponding to each online community used by the user according to the search request comprises: adding the keyword contained in the search request, information of the online community, and the user relationship chain of the user in the online community into a sub-search request, where the user relationship chain of the user in each online community includes friend information of the user in the online community; and
acquiring a search result corresponding to the sub-search request comprises: searching for all data information corresponding to the keyword contained in the sub-search request, according to indexes created for data information of each user in each online community used by the user; and filtering the searched out data information using the online community information and the user relationship chain of the user in the online community, which are carried in the sub-search request, to acquire the search result corresponding to the sub-search request.

8. A trans-community search apparatus, comprising a receiving unit, a community determining unit, a search unit and an output unit, wherein:
the receiving unit is configured to receive a search request from a user;
the community determining unit is configured to determine online communities used by the user according to user attribute information carried in the search request;
the search unit is configured to generate a sub-search request corresponding to each online community used by the user according to the search request and acquiring a search result corresponding to the sub-search request; and
the output unit is configured to combine search results corresponding to all sub-search requests and sending the combined search results to the user.

9. The trans-community search apparatus according to claim 8, further comprising a table generating unit, wherein:
the table generating unit is configured to pre-determine the online communities used by each user and generate a community-user mapping table corresponding to the user, wherein the community-user mapping table comprises information of each online community used by the user; and
the community determining unit is configured to, when determining the online communities used by the user according to user attribute information carried in the search request, search for a community-user mapping table corresponding to the user according to the user attribute information carried in the search request and determining the online communities used by the user according to online community information in the searched out community-user mapping table

10. The trans-community search apparatus according to claim 9, wherein:
the table generating unit is configured to pre-store attribute information and characteristic information of each user and information of each online community; and
the table generating unit is configured to: when pre-determining the online communities used by each user and generating a community-user mapping table corresponding to the user, acquire the characteristic information of each community user in each online community; searching for a user with the same characteristic information as the community user; and if the user with the same characteristic information as the community user is searched out, determining the online community containing the community user as an online community used by the user searched out; and adding attribute information of the user searched out, information of the online community, and the attribute information of the community user to a community-user mapping table corresponding to the user searched out.

11. The trans-community search apparatus according to claim 10, wherein: the user characteristic information comprises at least one of first characteristic information, second characteristic information and third characteristic information, wherein the first characteristic information comprises a name, an age and an address information, the second characteristic information comprises an instant messenger account, and the third characteristic information comprises an email address.

12. The trans-community search apparatus according to claim 9, further comprising a configuration unit, wherein:
the configuration unit is configured to preset an online community usage submitting interface; and
the table generating unit is configured to: when pre-determining the online communities used by each user and generating a community-user mapping table corresponding to the user, receive online community usage information which is submitted by the user using the preset online community usage submitting interface, where the online community usage information comprises information of each online community used by the user and community user attribute information of the user in each online community used by the user; determining the online communities used by the user according to the information of each online community that is contained in the online community usage information submitted by the user; and adding the attribute information of the user, the information of each online community used by the user, and the community user attribute information of the user in each online community used by the user to a community-user mapping table corresponding to the user.

13. The trans-community search apparatus according to claim 9, wherein:
the user attribute information is an identifier of a user;
the online community information is an identifier ID of an online community; and
the community user attribute information is an identifier of a community user in an online community containing the community user.

14. The trans-community search apparatus according to claim 8, wherein:
the search request further comprises a keyword;
the search unit is configured to, when generating a sub-search request corresponding to each online community used by the user according to the search request, add the keyword contained in the search request, information of the online community, and the user relationship chain of the user in the online community into a sub-search request, where the user relationship chain of the user in each online community includes friend information of the user in the online community; and
the search unit is configured to: when acquiring a search result corresponding to the sub-search request, search for all data information corresponding to the keyword contained in the sub-search request, according to indexes created for data information of each user in each online community used by the user; and filter the searched out data information using the online community information and the user relationship chain of the user in the online community, which are carried in the sub-search request, to acquire the search result corresponding to the sub-search request.

15. A machine-readable medium on which an instruction set is stored, wherein the instruction set, when executed by a machine, is configured to instruct the machine to perform the method according to claim 1.
